(19) United States
(12) Patent Application Publication
(10) Pub. No.: US 2004/0044726 A1
(43) Pub. Date: Mar. 4, 2004

(54) Service creation and provision using a java environment with a set of APIs for integrated networks called JAIN and a set of recommendations called the PARLAY API's

(75) Inventors: Houssam Owayed, Ottawa (CA); Linda Piotrowski, Chadds Ford, PA (US)

Correspondence Address: Ms. Linda Welti-Piotrowski, Chairman, Telecom One Technologies Inc., 4001 Kennett Pike, Ste. 134-220, Wilmington, DE, 19807, US

(73) Assignee: Telecom One Technologies Inc.

(21) Appl. No.: 10/230,456

(22) Filed: Aug. 28, 2002

(51) Int. Cl. G06F 15/16

(52) U.S. Cl. 709/203

(57) ABSTRACT

Recently a series of telecommunications companies together with computer hardware/software companies (Sun, IBM) committed their efforts for building abstractions from multivendor, multiprotocol telephony devices and protocols. These efforts materialized into various products and standards. Most recently the PARLAY group published a set of recommendations called the PARLAY APIs. Sun introduced a JAVA environment with a set of APIs for Integrated Networks called JAIN (pending publication), and IBM produced the JSLEE server, which integrates the JAIN and JCC classes of Sun in an automated Java environment for the implementation of telephony based applications.

A Java environment of this kind includes a JSLEE server which permits differing services to be provisioned to customers. Whenever an update of a service provisioned to a particular customer is required, such update is carried out centrally at a service creation point. In the service creation point, data defining the current executable code deployed at the JSLEE server for that customer is recovered to enable recreation of the existing executable code to be carried out. The current code may then be modified regardless of which service creation point is carrying out the modification.

### DESCRIPTION

1. Field of the Invention.

This invention relates to a Java based Service Logic Execution Environment (JSLEE), and particularly to a high level programming model for hosting voice and data services written in Java so services can be created to communicate to multiple networks—wireline, wireless, and the Internet.

2. Background of the Invention

Computer technology has improved drastically in the past thirty years. One of the results of the improvement is that the price of a computer having similar computation power dropped exponentially. As more and more companies and homes acquire computers, there is a desire to connect them together to share both voice and data information. As a result, data communication technology (such as local and wide area networks) underwent major development. This technology allows computer data to be easily transferred between computers.

The Internet, a wide-area data network, is used as a communications medium for users to purchase services and products. In this application, “merchants” display product and ordering information as web documents. Customers can review the documents and place orders by clicking on (i.e., selecting) appropriate places on the documents. Information about an order (e.g., model number and quantity) and its associated customer (e.g., name and shipping address) is transmitted electronically.

The voice network (PSTN) has evolved from hardwired services, to packaged services on SCPs (service control points), to packaged services on service nodes and intelligent peripherals, to packaged services on the edge of network devices (such as soft switches and call agents). Customer equipment has evolved through the creation of advanced PBX and call center solutions to various smart phone solutions built around APIs like Telephony API (TAPI) and Telephony Services API (TSAPI).

As communications networks become more integrated with e-business systems, customers are demanding that the underlying networks and service providers support the creation of ubiquitous services. There are two paths for creating and provisioning services—the communications network and the customer equipment. Both data and voice communications technologies are needed for e-business applications, however, creating and provisioning data and voice services has been difficult. One of the reasons is that these two technologies follow different protocols and, services designed for one technology cannot communicate with services designed for the other technology. Therefore, it is desirable to create and provision services that can communicate with both technologies. These services will combine the routing knowledge and connection capabilities of the communications network with personal and corporate knowledge to deliver highly personalized services. These services will not be pre-packaged, instead they will be customized and provisioned by the customer using e-business technologies.

Our invention is the glue that binds the communications and e-business technologies, and the hub between networks hosting the next generation of enhanced services.

### SUMMARY OF THE INVENTION

The present invention involves implementations of the JSLEE and JCC and supports JAIN TCAP as an additional protocol with the Ulticom JTCAP implementation. The JSLEE provides the execution environment including server startup, initial service loading and initialization, registration of communication events with services to handle those events, and access to application and communication capabilities within the services.

The JCC provides call control capabilities to services executing in the JSLEE. Services are built using an abstraction of these capabilities in a manner analogous to the abstraction JCC provides for call control services. Many new services are based on the integration of the communications network with information from non-communication network sources. These sources might include service provider databases, customer databases, Web-based information or real time systems. Common scenarios include accessing databases using JDBC, interacting with Web servers using servlets and Enterprise Java Beans (EJBs), accessing existing systems using message queues, and incorporating other communications functions through servers providing voice and call center capabilities. All these scenarios can be accessed through Java interfaces, and most of the code to use these interfaces is generated for Java using wizards.

These and other features of the present invention will become apparent from the following description when read in conjunction with the accompanying drawings.

### BRIEF DESCRIPTION OF THE DRAWINGS

FIG. 1 shows the main architecture of the present invention.

FIG. 2 shows the design of part of the CallAnswer application, and the connection between the various DirectTalk beans of the present invention.

FIG. 3 shows the connections between the DirectTalk beans and the Database Access beans in the FrenchMenu bean in accordance with the present invention.

FIG. 4: shows the main window of the Operator Dialog of the present invention.

FIG. 5 shows the main window of the operator to collect information from a new customer with the present invention.

FIG. 6 shows the Basic interaction between the operator dialog and DB2 with the present invention.

FIG. 7 shows the Basic interaction between the Chat dialog and DB2 with the present invention.

FIG. 8 shows the Functions of the system from the standpoint of the user with the present invention.

### DETAILED DESCRIPTION OF THE INVENTION

The present invention comprises a novel implementation of a call center service and related concept of what a enhanced call center service can do. The following description is presented to enable any person skilled in the art to make and use the invention. Description of a specific application is provided only as an example. Various modifications to the preferred embodiments will be readily apparent to those skilled in the art, and the general principles defined may be applied to other embodiments and applications without departing from the spirit and scope of the invention. Thus, the present invention is not intended to be limited to the embodiments shown, but is to be accorded the widest scope consistent with the principles and features disclosed herein.

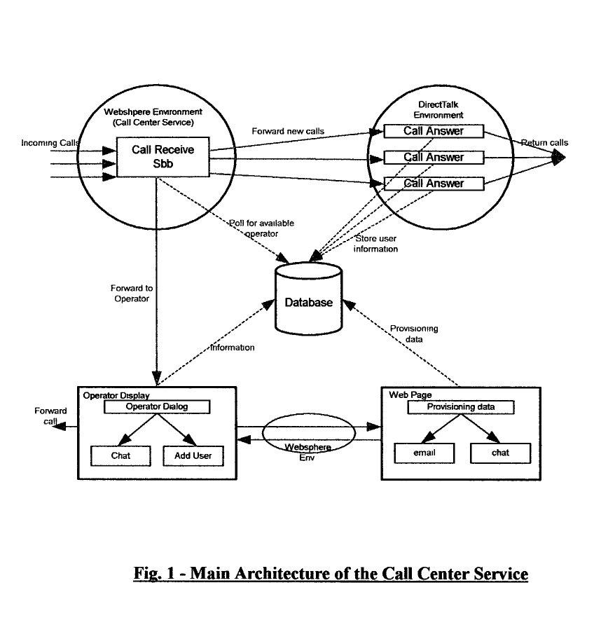

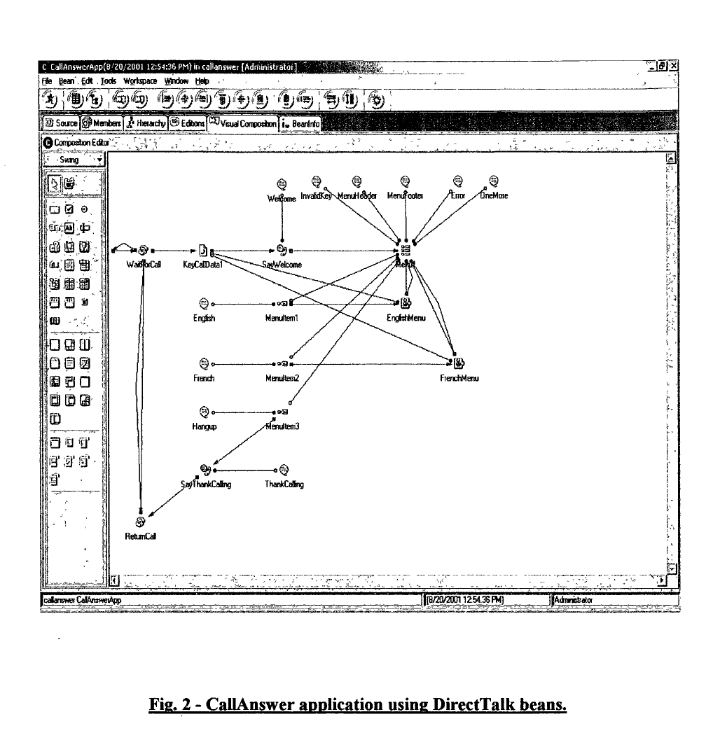

FIG. 1 shows the main architecture of the Call Center service. The arrows represent the communication between the different modules. Solid arrows represent “calls”, while dashed arrows represent parameter passing between the different modules.

The diagram shows the Call Receive Service Building Block (SBB) running in the Websphere environment (which is shaded yellow), but also shows all the modules related to the Websphere environment (also shaded yellow), which are the Operator Display, the Web Page, and the Database.

The Call Answer applications run in the DirectTalk environment (which is shaded blue), and the diagram also shows the relationship between the Database (with part of it shaded blue as well) and the DirectTalk environment, since the latter is used by the Call Answer application to store caller information.

The CallReceive Sbb runs in the Websphere environment, and is solely responsible for all the call control capabilities of the Call Center. It is triggered on an Incoming Call message, and transfers the call to the relevant parties in the implementation.

It collects input from the caller by forwarding the call to the CallAnswer application. The input collected is stored in a DB2 table called IncomingCalls, and represents the caller's choices of language and department. The user is then put on hold, and connected to the next available operator.

Because this Sbb runs in the JAIN SLEE and the CallAnswer application runs in the DirectTalk environment, the easiest way to communicate would be by forwarding the call back and forth between both environments.

This is a class that is launched in a thread, and which collects input from the caller to store in a DB2 table. It is implemented using the DirectTalk beans, and requires the DirectTalk environment to run.

The CallAnswer application asks the caller to choose a language by pushing the “1” button (for English) or the “2” button (for French). Any other keys are not recognized, and the caller is asked to retry for a maximum of 3 prompts, whereupon the call is terminated.

The caller is then prompted for a desired service department. “1” for finance, “2” for marketing, “3” for technical help, and “0” to speak with any operator. The service has been implemented such that if a customer presses “0” to speak with any operator, the call is forwarded to a default department (In this case, marketing). Operators from this department will receive calls both from callers who wish to speak to someone in this department and from the callers who dial “0”.

Different designs should be used later on for this implementation. It is possible to provision “general operators” to respond to these kind of queries. Any other keys are not recognized, and the caller is asked to retry for a maximum of 3 prompts, whereupon the call is terminated.

The collected information is used to store the caller's information in the DB2 IncomingCalls table. The OperatorDialog Class reads the information of the caller from the IncomingCalls table and displays the relevant information to an operator in the appropriate department once the call is connected to that operator.

The caller's telephone number is stored in the IncomingCalls table as well, and after all the relevant information is collected, the “ready” field in the table is set to “yes” and the caller is placed on hold.

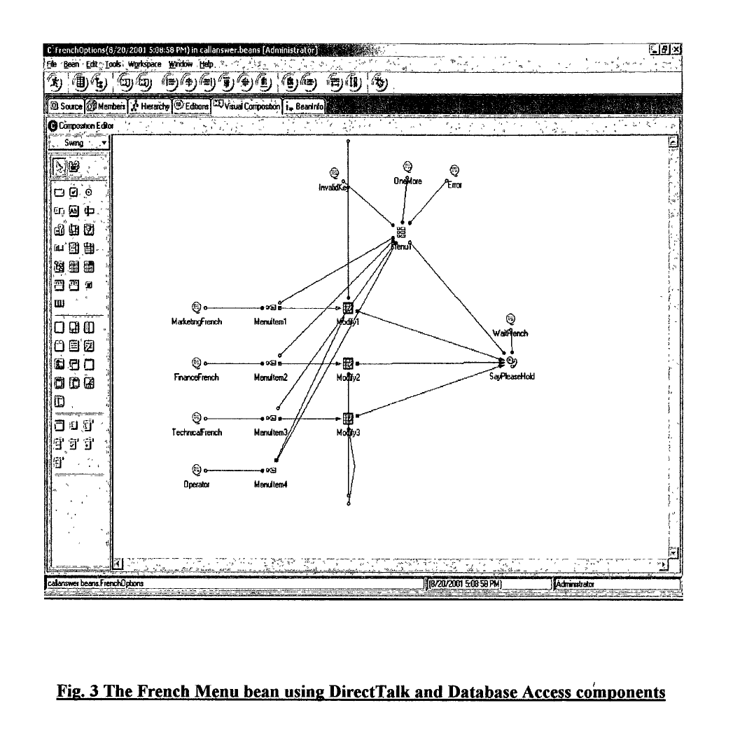

FIG. 2 shows the design of part of the CallAnswer application, and the connection between the various DirectTalk beans.

1) The call is answered by the WaitForCall bean, which waits for a call from the start of the application.

2) The KeyCallData1 bean stores the caller's telephone number.

3) The SayWelcome bean greets the caller.

4) The Menu bean reads the menu, and depending on the caller input, directs the caller either to the FrenchMenu bean, the English menu bean, or the other options.

If the caller chooses to exit prematurely, the application thanks them for calling, and ends the call.

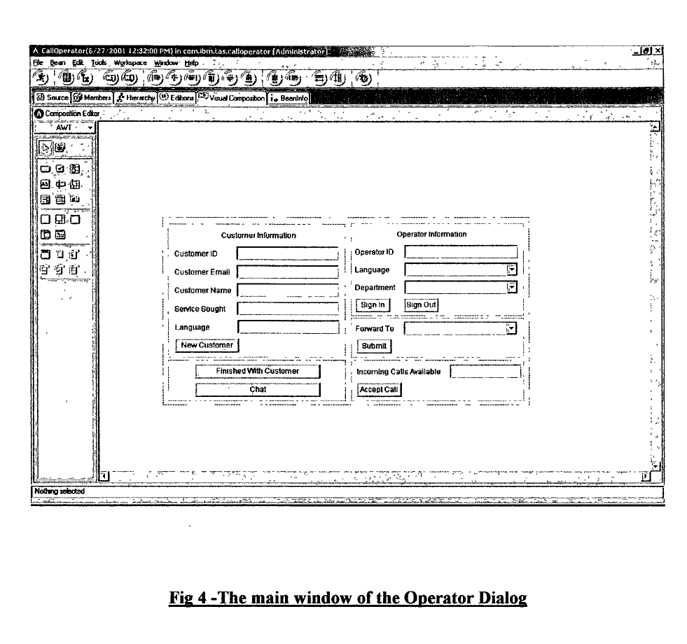

FIG. 3 shows the FrenchMenu bean using DirectTalk and Database Access components. The EnglishMenu and FrenchMenu beans include the design of the menu options in English and French respectively. They also implement the data storage in DB2.

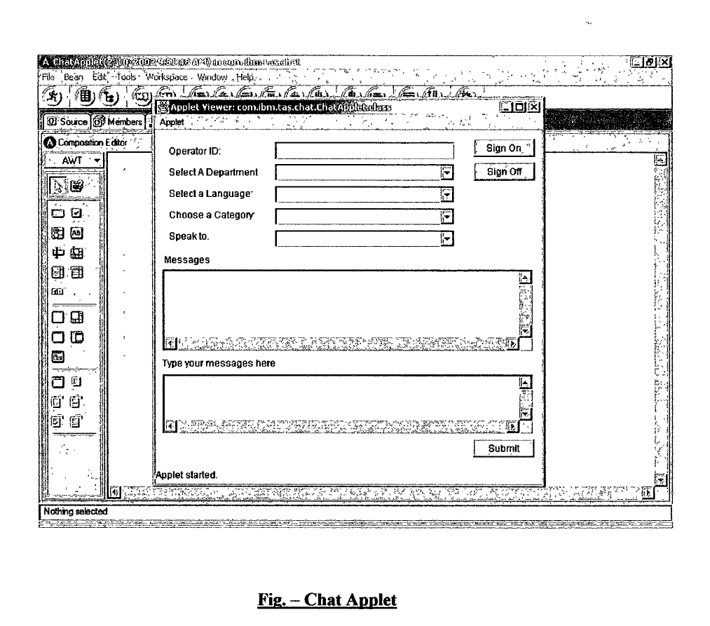

FIG. 4: shows the main window of the Operator Dialog_using the_CallOperator Class: This class includes the Operator dialog through which the operator interacts with the user. It displays information from the caller onto the screen, and provides capabilities for the operator such as a “talk” or “chat” between the operator and another operator, or between the operator and a user on the website. The operators can preview incoming calls to see if they want to accept the calls or not, and can forward the call to another department if they cannot provide sufficient assistance to the caller.

The operator starts by entering an operator ID (in the “Operator ID” textbox), choosing a language to speak in (by selecting from the “Language” combo box), and choosing a department to answer calls for (by selecting from the “Department” combo box). The operator then clicks on “Sign In” to log on.

Available Languages:

1) English

2) French

Available Departments:

1) Marketing

2) Finance

3) Technical Assistance

Customer Information Display:

1) The caller's phone number is displayed in the “Customer ID” textbox

2) The caller's language of preference is displayed in the “Language” textbox

3) The department the caller is looking for assistance from is displayed in the “Department Sought” textbox

There are two types of callers assumed for the service; caller's who are already customers of the company, and callers who are calling for the first time to enquire about a service and are not yet registered as customers. If the caller is a registered customer,

4) The caller's email address is displayed in the “Customer Email” textbox and

5) The caller's name is displayed in the “Customer Name” textbox so they can be greeted by the operator by name

If the caller is not a registered customer, the operator can enter new data for the caller if so desired. The operator therefore clicks the “New Customer” button, collects information from the caller, and stores in the Call Center Database.

After Login:

After the operator logs on, the number of waiting calls that match the operator's language and department settings is shown in the “Incoming Calls Available” textbox, and the information of the first caller in the queue is displayed. The operator must click the “Accept Call” button to be able to speak with the caller.

Call Transfer:

It is possible that the operator deems it necessary to forward the call to an operator in another department because the caller would be better served by someone from that department. In this case, the operator selects a department from the “Forward To” combo box, and clicks the “Submit” button to complete the transfer. After the call is transferred, the next waiting call is displayed on the screen in the same manner as part C (After Login), and the operator is again required to click the “Accept Call” button in order to speak with the caller.

End of Call:

When the operator is done speaking with the caller, the operator clicks on the “Finished With Customer” button. The next waiting call is displayed on the screen in the same manner as part C (After Login), and the operator is again required to click the “Accept Call” button in order to speak with the caller.

Chat:

The operator may wish to interact with another operator in the same department or in a different department while talking with the customer. The operator may also wish to “chat” with users who have accessed the web page and sent messages to the operators in the department. In both cases, the operator clicks the “Chat” button, which opens up another dialog with the “chat” capabilities.

Sign Off:

The operator must sign off when taking a break or leaving for the day. This ensures that no calls are sent to that operator and no callers are left waiting indefinitely. Immediately an operator signs on, a call is assigned to that operator (even before the operator accepts the call). Operators signing on after this time are assigned the next calls in the queue. Therefore when an operator logs off, the caller who was assigned to that operator still maintains top priority in the queue, but may have had other callers after him/her assigned to operators logging on after this operator. If the operator doesn't sign off, the waiting call will not be put back in the queue to be picked up by the next available operator, and the customer will be left on hold till the same operator comes back to accept the call.

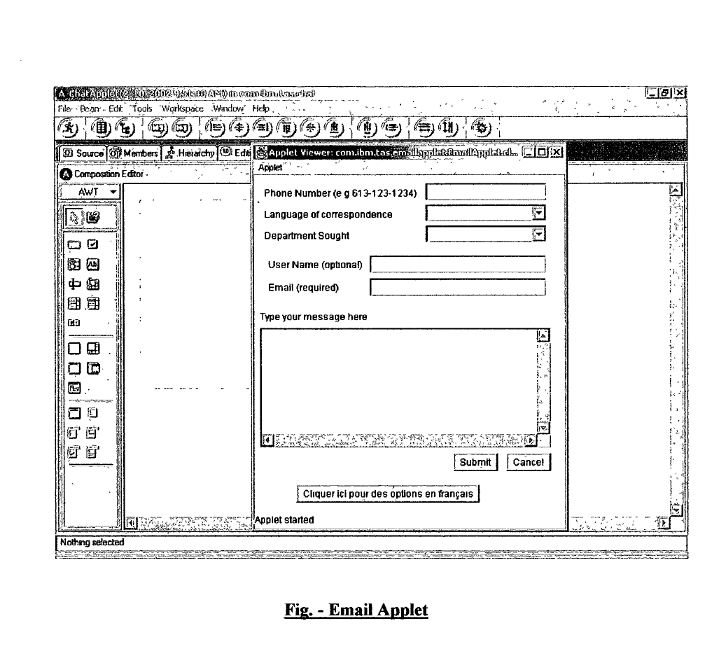

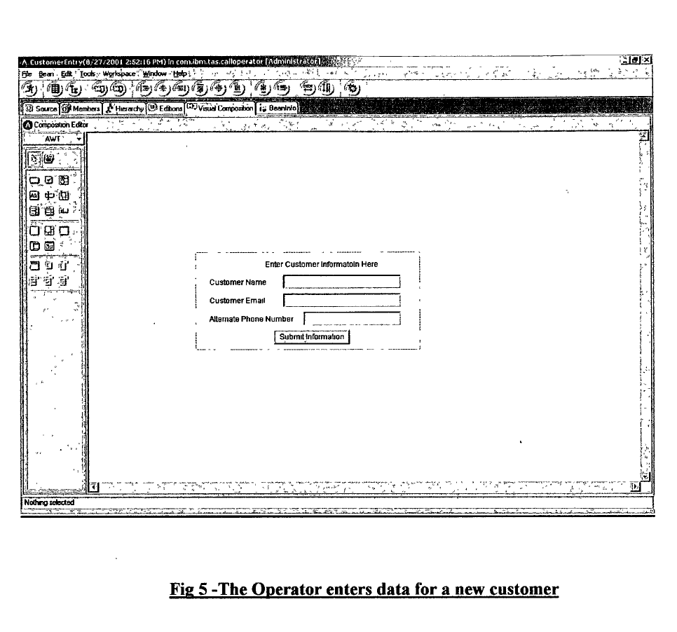

FIG. 5: shows the Operator enters data for a new customer The CustomerEntry Class.

This is the class that allows the operator to collect information from a new customer. The operator asks the caller for the required information, and clicks on “Submit Information”. The new data is stored in the Call Center database for future reference.

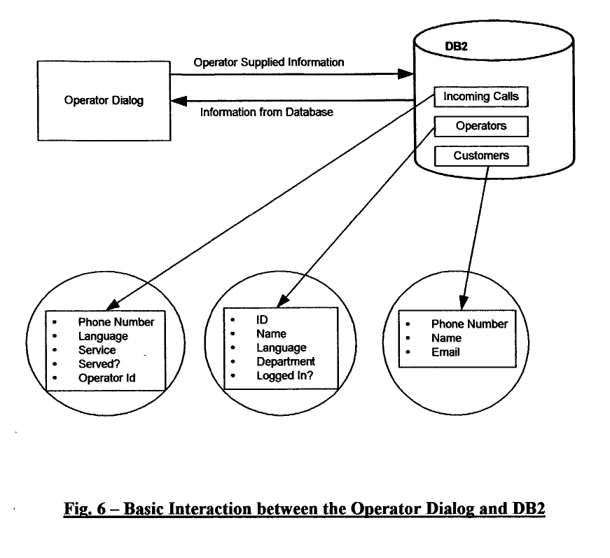

FIG. 6: shows the basic interaction between the operator dialog and DB2. The Operator interacts with 3 main tables in the database: The “INCOMINGCALLS” table, the “OPERATORS” table, and the “CUSTOMERS” table. The following diagram shows this relationship.

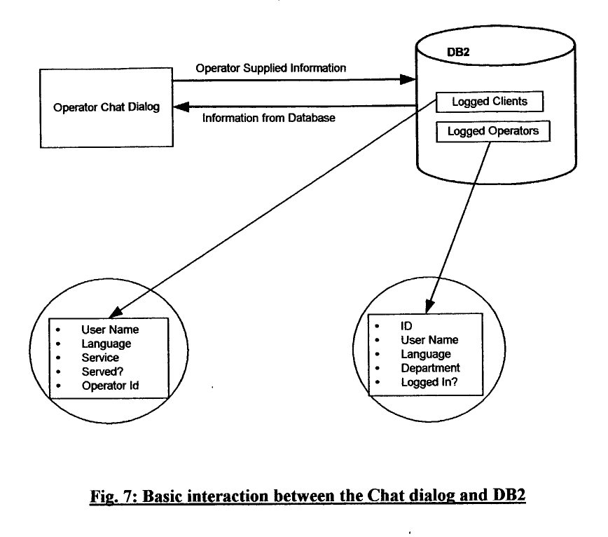

FIG. 7: shows the basic interaction between the Chat dialog and DB2 . The Chat dialog also interacts with the database via 2 tables: Logged Clients, which carries information of customers willing to chat, and Logged Operators, which carries the information of operators willing to chat.

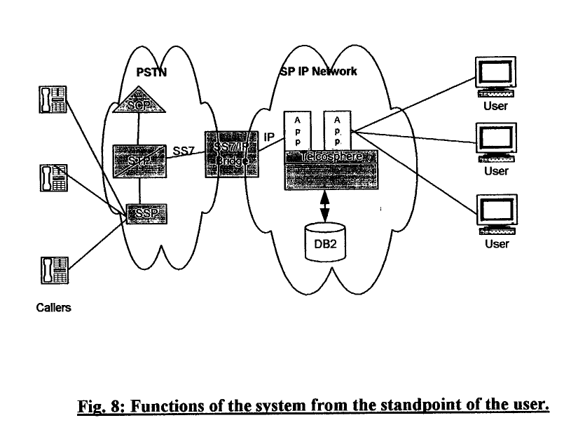

FIG. 8: shows the functions of the system from the standpoint of the user.

The Phone System:

The caller must have a digital phone to interact with the system. Although this is a considered aspect in the design of the system, this is the only stipulation that can be given from the designer standpoint. The type of phone and its capabilities depend on its owner, and the only requirement from the standpoint of the designed call center service is that the caller have the ability to listen to and respond to messages either by voice or by DTMF (touch tone) signals.

The Web Page:

The Web page has a simple set of requirements:

1) It should contain basic information about the company's services

2) It should give the user the ability to register (or subscribe) to some of the services

3) It should provide the ability to communicate with an operator by email

4) It should provide the ability to communicate with an operator by “chat” session

5) It should have a Frequently Asked Questions section

6) It should provide the ability to add provisioning data; the operator phone numbers and the phone numbers of the Call Answer applications

The services the user subscribes to are not related to the services used to build the call center service. In other words, the provisioning done by VisualAge Java is not for the benefit of the customers to the service as in the case of the Call Forwarding and Call Blocking examples. The call center uses the Call Receive service, which needs two sets of provisioning data: the operator phone numbers and the Call Answer applications' phone numbers.

The services the user subscribes to are services offered by the company using the Call Center, for example, applying to become a customer of Telecom One.

Providing the Ability to Register:

This design needs three pieces of information from the user. These are: name, telephone number and email address.

Providing the Ability to Communicate with an Operator by email:

The email service as described earlier in this document, works by having the user send a message to the operator using their email address (i.e. an email icon on the web page which launches the user's local email application enabling them to write a message). This email is sent to an operator account (which can be any email account accessible to all operators in a specific department), and the response is sent to the customer's inbox.

Providing the Ability to Communicate with an Operator by “chat” Session:

The chat session on the web page works in similar fashion to that of the operator. It requires a user name and a selection of a particular department to speak with and a language of correspondence. Upon request, the user is connected to an available operator, and can communicate messages back and forth.

Providing the Ability to add Provisioning Data:

A section will be included for entering information of new operators for the call center. The information included should be the operator name and the operator phone number (or extension).

A section will also be provided for adding a new number to which calls can be forwarded. The more numbers available, the more customers can be handled simultaneously. The Call Answer applications are assigned these phone numbers.

The invention has been described with reference to specific exemplary embodiments thereof. Various modification and changes may be made thereunto without departing from the broad spirit and scope of the invention. The specification and drawings are, accordingly, to be rewarded in an illustrative rather than a restrictive sense; the invention is limited only by the provided claims.

What is claimed is:

1. A Java environment with a set of APIs including:
The JAIN TCAP API that will provide the interfaces and classes required to initialize and terminate a TCAP session, manage TCAP dialogue identifiers, retrieve, build and send dialogue and component primitives. TCAP provides the means for the invocation of remote operations between signaling point nodes and thus provides generic services to applications such as mobile telephony and free phone service,
at least one JSLEE server architected as a robust, event driven rapid response service execution platform optimized for integration with telecom networks, supporting the installation, execution, management, and removal of telecom services, and
one or more service creation points, each capable of acting on data in the JSLEE server to modify translations,
wherein, each service creation point includes means arranged to recover existing service defining data from the respective JSLEE server to permit an exact replica of the current service provided to the particular customer to be constructed prior to effecting modification of service relating to a specified customer number.

2. A communications service as in claim 1, wherein:
the service defining data shall be all built based on Java classes and shall include the Websphere/TelcoSphere Java classes of IBM embedded as instruction information within executable code interacting with the JSLEE server.

3. A service as in claim 2, wherein;
the data defining the respective executable code is encoded as instructions within the executable code.

4. A method of selectively activating services to customers of a communications network, said method including:
storing at the JSLEE server respective executable code defining services to be provided for each customer,
providing for each customer respective customer-modifiable data to permit the respective customer to determine how defined services are used, and
amending the services provided to a respective customer by:
copying data defining the respective executable code to a remote service creation point,
recreating the respective executable code at the service creation point, amending the executable code at the service creation point, and deploying the amended code at the JSLEE server.
